(19) United States
(12) Patent Application Publication
(10) Pub. No.: US 2022/0366589 A1
(43) Pub. Date: Nov. 17, 2022

(54) DISPARITY DETERMINATION

(71) Applicant: BEIJING BAIDU NETCOM SCIENCE TECHNOLOGY CO., LTD., Beijing (CN)

(72) Inventors: Zhikang ZOU, Beijing (CN); Xiaoqing YE, Beijing (CN); Hao SUN, Beijing (CN)

(21) Appl. No.: 17/876,408

(22) Filed: Jul. 28, 2022

(30) Foreign Application Priority Data
Sep. 16, 2021 (CN) 202111087988.6

(51) Int. Cl. G06T 7/593; G06T 3/40

(52) U.S. Cl. CPC G06T 7/593; G06T 3/40; G06T 2207/20084; G06T 2207/20221

(57) ABSTRACT

A method of determining disparity is provided. The implementation scheme is: obtaining a plurality of images corresponding to a target view, wherein each image in the plurality of images is obtained by performing size adjustment on the target view, and each image in the plurality of images has the same size as a feature map output by a corresponding layer structure in a disparity refinement network; and obtaining a refined disparity map output by the disparity refinement network by at least inputting an initial disparity map into the disparity refinement network, and fusing each image in the plurality of images and the feature map output by the corresponding layer structure, wherein the initial disparity map is generated at least based on the target view.

### CROSS REFERENCE OF RELATED APPLICATIONS

This application claims priority to Chinese Patent Application No. 202111087988.6, filed on Sep. 16, 2021, the contents of which are hereby incorporated by reference in their entireties.

### TECHNICAL FIELD

The present disclosure relates to the field of artificial intelligence, particularly relates to a computer vision and deep learning technology, may be particularly used in a three-dimensional reconstruction scene, and particularly relates to a method and an apparatus of determining disparity, an electronic device, a computer readable storage medium and a computer program product.

### DESCRIPTION OF THE RELATED ART

Artificial intelligence is a subject for studying to enable a computer to simulate a certain thought process and intelligent behavior (such as learning, reasoning, thinking and planning) of people, and has both a technology in a hardware level and a technology in a software level. An artificial intelligence hardware technology generally includes technologies such as a sensor, a dedicated artificial intelligence chip, cloud computing, distributed storage and big data processing. An artificial intelligence software technology mainly includes several major directions of a computer vision technology, a speech recognition technology, a natural language processing technology, a machine learning/deep learning technology, a big data processing technology, a knowledge mapping technology, etc.

It is of great significance to apply the deep learning technology to binocular stereo matching. In the related technology, there is still a great part of the room for improvement of generation and refining of a disparity map in binocular stereo matching.

A method described in this part is not necessarily a method that has been thought or adopted previously. Unless otherwise specified, it should not assume that any method described in this part is regarded as the prior art only because it is included in this part. Similarly, unless otherwise specified, a problem mentioned in this part should not be regarded as being publicly known in the prior art.

### BRIEF SUMMARY

The present disclosure provides a method and an apparatus of determining disparity, an electronic device, a computer readable storage medium and a computer program product.

According to an aspect of the present disclosure, a method of determining disparity by utilizing a disparity refinement network is provided, the disparity refinement network includes a plurality of cascaded layer structures, and the method includes: obtaining a plurality of images corresponding to a target view, wherein each image in the plurality of images is obtained by performing size adjustment on the target view, and each image in the plurality of images has the same size as a feature map output by a corresponding layer structure in the disparity refinement network; generating an initial disparity map at least based on the target view; and obtaining a refined disparity map output by the disparity refinement network based on at least inputting the initial disparity map into the disparity refinement network, fusing each image in the plurality of images and the feature map output by the corresponding layer structure, and inputting an image obtained by the fusing into the disparity refinement network.

According to another aspect of the present disclosure, an electronic device is provided, including: one or more processors; and a memory storing one or more programs configured to be executed by the one or more processors, the one or more processors comprising instructions for causing the electronic device to perform operations comprising: obtaining a plurality of images corresponding to a target view, wherein each image in the plurality of images is obtained by performing size adjustment on the target view, and each image in the plurality of images has the same size as a feature map output by a corresponding layer structure in the disparity refinement network; generating an initial disparity map at least based on the target view; and obtaining a refined disparity map output by the disparity refinement network by at least inputting the initial disparity map into the disparity refinement network, fusing each image in the plurality of images and the feature map output by the corresponding layer structure, and inputting an image obtained by the fusing into the disparity refinement network.

According to another aspect of the present disclosure, a non-transient computer readable storage medium storing one or more programs, the one or more programs comprising instructions, which when executed by one or more processors of an electronic device, cause the electronic device to perform operations comprising: obtaining a plurality of images corresponding to a target view, wherein each image in the plurality of images is obtained by performing size adjustment on the target view, and each image in the plurality of images has the same size as a feature map output by a corresponding layer structure in the disparity refinement network; generating an initial disparity map at least based on the target view; and obtaining a refined disparity map output by the disparity refinement network by at least inputting the initial disparity map into the disparity refinement network, fusing each image in the plurality of images and the feature map output by the corresponding layer structure, and inputting an image obtained by the fusing into the disparity refinement network.

According to one or more embodiments of the present disclosure, the quality of a disparity map may be improved.

It should be understood that the content described in this part is not intended to identify the key or important features of the embodiments of the present disclosure, and is not used for limiting the scope of the present disclosure as well. Other features of the present disclosure will be easily understood through the following specification.

### BRIEF DESCRIPTION OF THE SEVERAL VIEWS OF THE DRAWINGS

Accompanying drawings, as examples, show the embodiments, constitute a part of the specification, and together with text description of the specification, serve to explain example implementations of the embodiments. The shown embodiments are only for the purpose of illustration, and do not limit the scope of the claims. In all the accompanying drawings, the same reference numerals refer to the similar but not necessarily the same elements.

FIG. 1 shows a schematic diagram of an example system in which various methods described herein may be implemented according to some embodiments of the present disclosure.

FIG. 2 shows a flow diagram of a method of determining disparity according to some embodiments of the present disclosure.

FIG. 3 shows a flow diagram of obtaining a refined disparity map in the method shown in FIG. 2 according to some embodiments of the present disclosure.

FIG. 4 shows a flow diagram of fusing in the method shown in FIG. 3 according to some embodiments of the present disclosure.

FIG. 5 shows a schematic diagram of determining disparity according to some embodiments of the present disclosure.

FIG. 6 shows a flow diagram of a method for training a disparity refinement network according to some embodiments of the present disclosure.

FIG. 7 shows an overall schematic diagram of disparity determining according to some embodiments of the present disclosure.

FIG. 8 shows a structure block diagram of an apparatus determining disparity according to some embodiments of the present disclosure.

FIG. 9 shows a structure block diagram of an apparatus for training a disparity refinement network according to some embodiments of the present disclosure.

FIG. 10 shows a structure block diagram of an example electronic device capable of being used for implementing some embodiments of the present disclosure.

### DETAILED DESCRIPTION

The example embodiments of the present disclosure are illustrated below with reference to the accompanying drawings, wherein including various details of the embodiments of the present disclosure for aiding understanding, and should be regarded as being only example. Therefore, those ordinarily skilled in the art should realize that various variations and modifications may be made on the embodiments described here without departing from the scope of the present disclosure. Similarly, for clarity and simplicity, the following description omits description of a publicly known function and structure.

In the present disclosure, unless otherwise noted, describing of various elements by using terms “first,” “second” and the like does not intend to limit a position relationship, a time sequence relationship or an importance relationship of these elements, and this kind of terms is only used for distinguishing one component from another component. In some examples, a first element and a second element may refer to the same instance of this element, while in certain cases, they may also refer to different instances based on the contextual description.

The terms used in description of various examples in the present disclosure are only for the purpose of describing the specific examples, and do not aim at limiting. Unless otherwise explicitly indicated in the context, if the quantity of the elements is not limited specially, this element may be one or more. In addition, the term “and/or” used in the present disclosure covers any one of all possible combination modes in the listed items.

The embodiments of the present disclosure will be described below in detail with reference to the accompanying drawings.

Binocular stereo matching is always a research hotspot of binocular vision, a binocular camera shoots left and right view images of the same scenario, and obtain a disparity map by applying a stereo matching algorithm, so as to obtain a depth map. It is of great significance to solve a binocular stereo matching problem by utilizing a deep learning technology, however, the generated disparity map always has the problems of much noise, inaccurate deep predicting and the like, so that one post-processing needs to be performed in combination with disparity map refinement. Disparity refinement may improve the quality of the disparity map, remove mistaken disparity and perform proper smoothing, so that a final disparity map has practical application significance.

In the related technology, disparity map refinement generally adopts a Left-Right Check algorithm to remove mistaken disparity caused by shielding and noise; adopts an algorithm for removing a small connection region to remove an isolated outlier; and adopts a smoothing algorithm such as Median Filter and Bilateral Filter to smooth the disparity map. In addition, there are further some methods for effectively improving the quality of the disparity map, such as Robust Plane Fitting, Intensity Consistent and Locally Consistent which are commonly used as well.

The relevant mainstream technology mainly depends on a geometrical relationship in traditional vision to perform modeling on part of regions in the disparity map and then corresponding refining, cannot give a guidance by combining with rich semantic information input into a binocular map. And in addition, the generated map is not close enough to a true disparity map.

The present application guides refinement of the disparity map by designing a disparity map refinement network and fusing information in a binocular image, so as to achieve a purpose of improving the quality of the disparity map, and may be used for measuring, three-dimensional reconstruction, synthesis of virtual viewpoint, and the like.

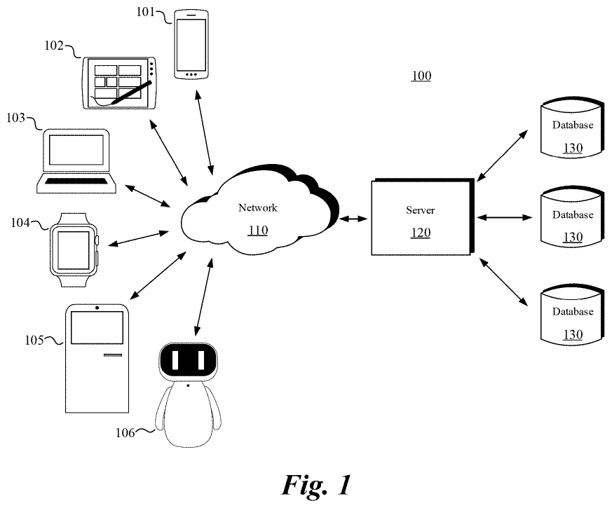

FIG. 1 shows a schematic diagram of an example system 100 in which various methods and apparatuses described herein may be implemented according to some embodiments of the present disclosure. Referring to FIG. 1, the system 100 includes one or more client devices 101, 102, 103, 104, 105 and 106, a server 120, and one or more communication networks 110 for coupling the one or more client devices to the server 120. The client devices 101, 102, 103, 104, 105 and 106 may be configured to execute one or more application programs.

In some embodiments of the present disclosure, the server 120 may run to be capable of executing one or more service or software applications of a disparity determining method.

In some embodiments, the server 120 may further provide other service or software applications including a non-virtual environment and a virtual environment. In certain embodiments, these services may serve as a web-based service or cloud service to be provided, for example, be provided to users of the client devices 101, 102, 103, 104, 105 and/or 106 under a software as a service (SaaS) model.

In configuration shown in FIG. 1, the server 120 may include one or more components for implementing functions executed by the server 120. These components may include a software component, a hardware component or their combinations capable of being executed by one or more processors. The users operating the client devices 101, 102, 103, 104, 105 and/or 106 may sequentially utilize one or more client application programs to interact with the server 120, so as to utilize the service provided by these components. It should be understood that various different system configurations are possible, and may be different from the system 100. Therefore, FIG. 1 is an example of a system used for implementing various methods described herein, and is not intended to limit.

The users may use the client devices 101, 102, 103, 104, 105 and/or 106 to determine disparity. The client devices may provide an interface enabling the users of the client devices to be capable of interacting with the client devices. The client devices may further output information via the interface. Although FIG. 1 describes the six client devices, those skilled in the art should understand that the present disclosure may support any number of client devices.

The client devices 101, 102, 103, 104, 105 and/or 106 may include various types of computer devices, such as a portable handheld device, a general-purpose computer (such as a personal computer and a laptop computer), a workstation computer, a wearable device, an intelligent screen device, a self-service terminal device, a service robot, a game system, a thin client, various message transceiving devices, a sensor or other sensing devices. These computer devices may run various types and versions of software application programs and operating systems, such as MICROSOFT Windows, APPLE iOS, a UNIX-like operating system, Linux or Linux-like operating system (such as GOOGLE Chrome OS); or include various mobile operating systems, such as MICROSOFT Windows Mobile OS, iOS, Windows Phone, and Android. The portable handheld device may include a cellular phone, a smart phone, a tablet computer, a personal digital assistant (PDA), etc. The wearable device may include a head-mounted display (such as smart glasses) and other devices. The game system may include various handheld game devices, a game device supporting Internet, etc. The client devices can execute various different application programs, such as various Internet-related application programs, a communication application program (such as an electronic mail application program), and a short message service (SMS) application program, and may use various communication protocols.

A network 110 may be any type of network well known by those skilled in the art, and it may use any one of various available protocols (including but not limited to TCP/IP, SNA, IPX, etc.) to support data communication. As an example only, one or more networks 110 may be a local area network (LAN), an Ethernet-based network, a Token-Ring, a wide area network (WAN), an Internet, a virtual network, a virtual private network (VPN), an intranet, an extranet, a public switched telephone network (PSTN), an Infrared network, a wireless network (such as Bluetooth and WIFI), and/or any combination of these and/or other networks.

The server 120 may include one or more general-purpose computers, dedicated server computers (such as personal computer (PC) servers, UNIX servers, and midrange servers), blade servers, mainframe computers, server clusters or any other proper arrangements and/or combinations. The server 120 may include one or more virtual machines running the operating system, or relate to other virtualized computing architectures (such as one or more flexible pools capable of being virtualized so as to maintain a logic storage device of a virtual storage device of the server. In various embodiments, the server 120 may run one or more service or software applications providing the functions described hereunder.

A computing unit in the server 120 may run one or more operating systems including any above operating system and any commercially available server operating system. The server 120 may further run any one of various additional server application programs and/or a middle tier application program, including an HTTP server, an FTP server, a CGI server, a JAVA server, a database server, etc.

In some implementations, the server 120 may include one or more application programs, so as to analyze and merge data feed and/or event update received from the users of the client devices 101, 102, 103, 104, 105 and 106. The server 120 may further include one or more application programs, so as to display the data feed and/or a real-time event via one or more display devices of the client devices 101, 102, 103, 104, 105 and 106.

In some implementations, the server 120 may be a server of a distributed system, or a server in combination with a blockchain. The server 120 may also be a cloud server, or an intelligent cloud computing server or an intelligent cloud host with an artificial intelligence technology. The cloud server is a hosting product in a cloud computing service system, so as to solve the defects of large management difficulty and weak business scalability in service of a traditional physical host and a Virtual Private Server (VPS).

The system 100 may further include one or more databases 130. In certain embodiments, these databases may be used for storing data and other information. For example, one or more of the databases 130 may be used for storing information such as an audio file and a video file. The databases 130 may be resident at various positions. For example, a database used by the server 120 may be at a server 120 local, or may be away from the server 120, and may be in communication with the server 120 via network-based or dedicated connection. The databases 130 may be in different types. In certain embodiments, the database used by the server 120 may be, for example, a relational database. One or more of these databases may store, update and retrieve data to the database and from the database in response to a command.

In certain embodiments, one or more of the databases 130 may further be used by an application program for storing application program data. The database used by the application program may be different types of databases, such as a key value memory pool, an object memory pool, or a conventional memory pool supported by a file system.

The system 100 in FIG. 1 may be configured and operated in various modes, so as to be capable of applying various methods and apparatuses described according to the present disclosure.

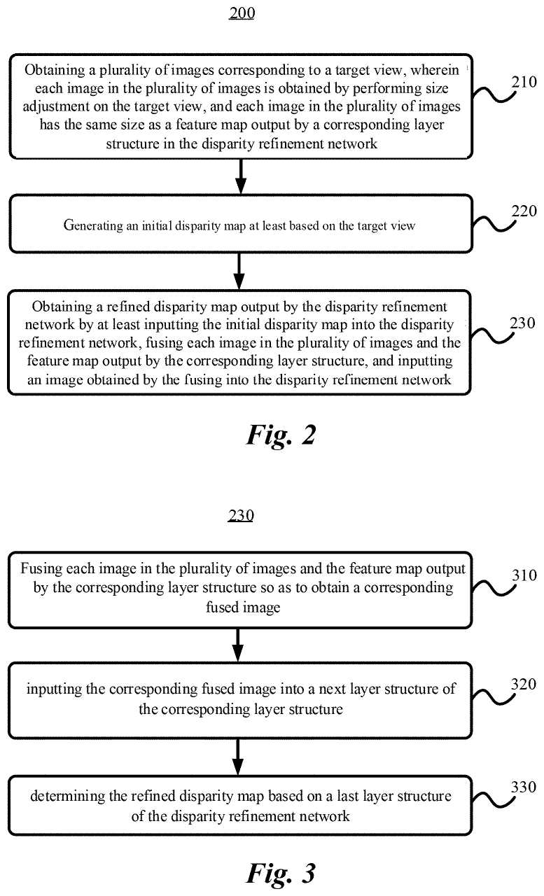

FIG. 2 shows a flow diagram of a method 200 of determining disparity according to some embodiments of the present disclosure. As shown in FIG. 2, the method 200 of determining disparity includes at least steps 210-230.

In step 210, a plurality of images corresponding to a target view are obtained, wherein each image in the plurality of images is obtained by performing size adjustment on the target view, and each image in the plurality of images has the same size as a feature map output by a corresponding layer structure in a disparity refinement network. In an example, the target view is one selected from left and right images in binocular vision. For example, the left image in the binocular vision may be selected as the target view, and then a plurality of images are generated by adjusting the size of the target view. Respective images correspond to different sizes. In an example, a length and a width of a target image may be both zoomed by ½, so as to obtain one image in the plurality of images. Then the image is further zoomed, for example, the length and the width are both zoomed by ½, so as to obtain another image in the plurality of images. In a similar fashion, the plurality of images with different sizes related to the target view may be obtained. In an example, the disparity refinement network includes a plurality of layer structures corresponding to the plurality of images in size, and the feature map output by each layer structure has the same size as the corresponding image in the plurality of images.

In step S220, an initial disparity map is generated at least based on the target view. In an example, the initial disparity map may be generated by utilizing the binocular vision, and the target image is used for generating one of the left image and the right image of the initial disparity map.

In step S230, a refined disparity map output by the disparity refinement network is obtained by at least inputting the initial disparity map into the disparity refinement network, fusing each image in the plurality of images and the feature map output by the corresponding layer structure, and inputting an image obtained by the fusing into the disparity refinement network. In an example, the feature map output by each layer structure in the disparity refinement network and the image having the same size as the feature map in the plurality of images are fused.

In some example implementations, by fusing the target views with the multiple sizes and the output feature maps of all the layer structures in the disparity refinement network, information in the target view is fully utilized in the method 200 to guide refinement of the initial disparity map. Therefore, the rich information in the target view may be combined in the method 200 to effectively reduce mistaken information in the disparity map and improve the quality of the disparity map.

In some example embodiments, each layer structure in the disparity refinement network includes a feature extraction layer and a pooling layer. In an example, through the feature extraction layer in each layer structure, the disparity refinement network can extract semantic information in the target view so as to generate the feature map. In addition, by adding the pooling layer into each layer structure, it can be ensured that the extracted feature map have the same size as the corresponding image in the plurality of images, so as to ensure subsequent fusing. In an example, the extracted semantic information may include, for example, contours, positions, pixel differences and the like of all objects in the image.

In some example embodiments, the fusing each image in the plurality of images and the feature map output by the corresponding layer structure is performed by channel stacking, matrix multiplication or matrix addition. In an example, the feature map is an N channel, the corresponding image in the plurality of images is a 3 channel, and thus fusing of the feature map and the corresponding image may be channel stacking, so as to obtain a fused image of an N+3 channel. Therefore, through the fusing operation, corresponding image information may be introduced into input of each layer structure to guide disparity map refinement.

In an example embodiment, the obtaining the refined disparity map output by the disparity refinement network includes that the target view and the initial disparity map are fused to obtain an initial fused image. Then, the initial fused image is input into the disparity refinement network to be refined. In an example, input of the first layer structure is the initial fused image obtained by fusing the initial disparity map and the target view.

FIG. 3 shows a flow diagram of obtaining the refined disparity map in the method 200 shown in FIG. 2 according to some embodiments of the present disclosure. As shown in FIG. 3, the obtaining the refined disparity map (step 230) may further include step 310 to step 330.

In step 310, each image in the plurality of images and the feature map output by the corresponding layer structure are fused so as to obtain a corresponding fused image.

In step 320, the corresponding fused image is input into a next layer structure of the corresponding layer structure.

In step 330, the refined disparity map is determined based on a last layer structure of the disparity refinement network.

In an example, output of each layer structure except for the last layer structure in the disparity refinement network and the corresponding image are fused, so as to obtain the corresponding fused image. Then, the fused image is input to the next layer structure. Output of the last layer structure of the disparity refinement network is not fused any more, but output as the refined disparity map. Therefore, by adopting a cascaded structure of the present embodiments, the features extracted by all the layer structures may be combined sequentially. With progressing of the layer structure, the size of the fused image is smaller and smaller, and the extracted feature is more and more abstract. In conclusion, according to some embodiments of the present disclosure, the multiple layers of structures may be utilized to extract the various features, thereby the quality of disparity map refinement may be improved.

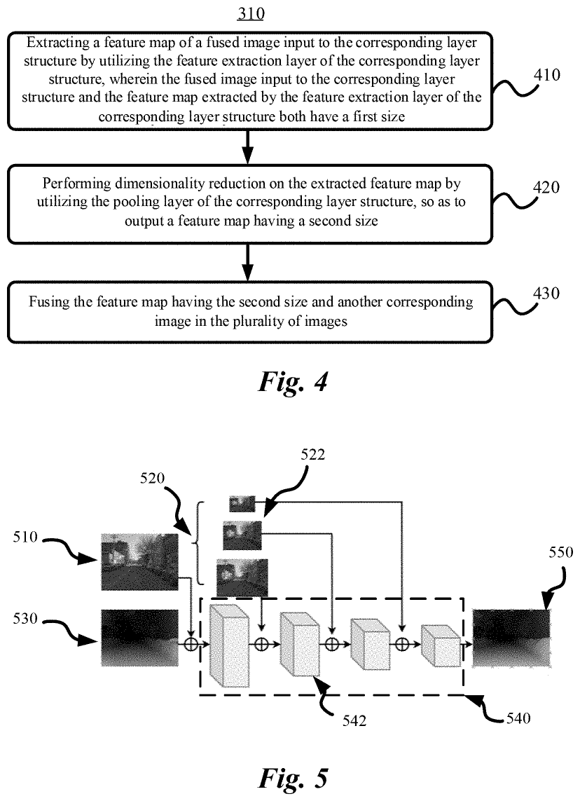

FIG. 4 shows a flow diagram of the fusing in the method shown in FIG. 3 according to some embodiments of the present disclosure. As shown in FIG. 3, the fusing each image in the plurality of images and the feature map output by the corresponding layer structure so as to obtain the corresponding fused image (step 310) includes step 410 to step 430.

In step 410, a feature map of a fused image input to the corresponding layer structure is extracted by utilizing the feature extraction layer of the corresponding layer structure, wherein the fused image input to the corresponding layer structure and the feature map extracted by the feature extraction layer of the corresponding layer structure both have a first size.

In step 420, dimensionality reduction is performed on the extracted feature map by utilizing the pooling layer of the corresponding layer structure, so as to output a feature map having a second size.

In step 430, the feature map having the second size and another corresponding image in the plurality of images are fused.

In an example, the feature extraction later in each layer structure may be used for extracting a feature of the fused image input the layer structure, so as to generate the feature map. The feature map has the same size as the fused image input to the layer structure. In order to further fuse information in image, the pooling layer in the layer structure may be utilized to perform dimensionality reduction on the feature map. For example, a length and a width of the feature map after dimensionality reduction is ½ of the length and the width of the original feature map. Therefore, the feature map after dimensionality reduction can have the corresponding size as the plurality of images generated, so as to ensure that all the layer structures can utilize the semantic information in the images to guide refinement of the disparity map.

In some example embodiments, the determining the refined disparity map based on the last layer structure of the disparity refinement network (step 330) includes that a feature map of a fused image input to the last layer structure is extracted by utilizing the last layer structure. Then upsampling is performed on the extracted feature map so as to obtain the refined disparity map, wherein the refined disparity map has the same size as the target view.

FIG. 5 shows a schematic diagram of determining disparity according to some embodiments of the present disclosure. As shown in FIG. 5, size adjustment may be performed on a target view 510 so as to generate a plurality of images 520. Respective images in the plurality of images 520 have different sizes. Firstly, the target view 510 and an initial disparity map 530 are fused to obtain an initial fused image. Then, the initial fused image is input into a disparity refinement network 540. Taking an image 522 as an example, an output feature map of a corresponding layer structure 542 in the disparity refinement network 540 has the same size as the image 522. Then the image 522 and the output feature map of the layer structure 542 may be fused so as to obtain the corresponding fused image. Similar operations are performed on other layer structures except for the last layer structure in the disparity refinement network 540. Finally, the last layer structure outputs a refined disparity map 550.

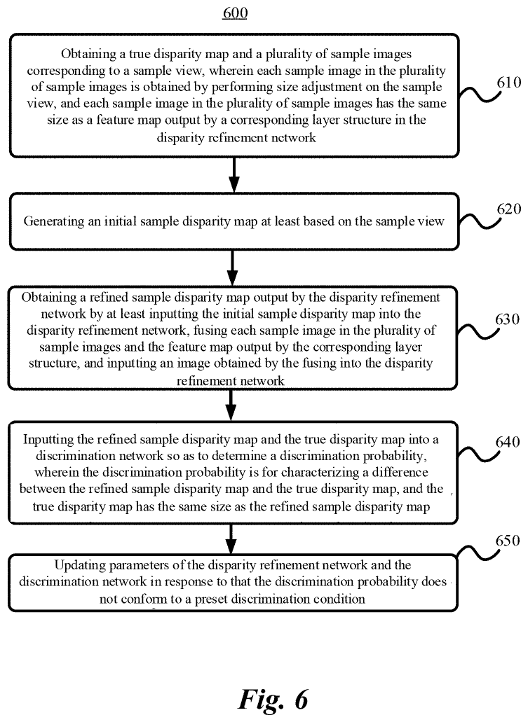

FIG. 6 shows a flow diagram of a method 600 of training a disparity refinement network according to some embodiments of the present disclosure. As shown in FIG. 6, the method 600 for perform learning training on the disparity refinement network includes iteration of steps 610-650.

In step 610, a true disparity map and a plurality of sample images corresponding to a sample view are obtained, wherein each sample image in the plurality of sample images is obtained by performing size adjustment on the sample view, and each sample image in the plurality of sample images has the same size as a feature map output by a corresponding layer structure in the disparity refinement network.

In step 620, an initial sample disparity map is generated at least based on the sample view.

In step 630, a refined sample disparity map output by the disparity refinement network is obtained by at least inputting the initial sample disparity map into the disparity refinement network, fusing each sample image in the plurality of sample images and the feature map output by the corresponding layer structure, and inputting an image obtained by the fusing into the disparity refinement network.

in step 640, the refined disparity map and the true disparity map are input into a discrimination network so as to determine a discrimination probability, wherein the discrimination probability is for characterizing a difference between the refined disparity map and the true disparity map, and the true disparity map has the same size as the refined disparity map. In an example, the true disparity map is a true disparity map with a label.

In step 650, parameters of the disparity refinement network and the discrimination network are updated in response to that the discrimination probability does not conform to a preset discrimination condition. In an example, the parameter of the discrimination network may be updated firstly by learning. After a good discrimination network is obtained, whether the refined disparity map is close to the true disparity map is determined. The parameter of the disparity refinement network is updated if the discrimination probability does not confirm to the preset discrimination condition.

The training method 600 performs iteration on steps 610-650, so as to obtain the trained disparity refinement network.

In an example embodiment, a generative adversarial discriminator is utilized for training, so that the refined disparity map output by the disparity refinement network may be closer to true disparity map. By adopting the principle of a generative adversarial network (GAN), the output refined disparity map and the true disparity map with the label together are sent to the discrimination network, to cause the discrimination network to learn and discriminate the true and the false of input maps, and to cause the disparity refinement network to update parameters according to the discrimination result.

In an example, the preset discrimination condition is for ensuring that the output refined disparity map is close to the true disparity map with the label as much as possible, so that the discrimination network cannot discriminate the true and the false. In an example, the discrimination condition may be the discrimination probability is equal to 0.5 or close to 0.5. At this time, probabilities of correct determination and wrong determination by the discrimination network are close, which represents that the discrimination network cannot determining the refined disparity map is the true or the false and the true disparity map is the true or the false. In such adversarial learning process, parameters of the disparity refinement network are constantly learned through training, and thus the quality of the generated refined disparity map is gradually improved.

In an example embodiment, the discrimination network includes a global discriminator and a local discriminator. The global discriminator takes the refined sample disparity map and the true disparity map as inputs. The local discriminator takes a first image sub-block of the refined sample disparity map and a second image sub-block of the true disparity map as inputs, and the first image sub-block and the second image sub-block have the same size. The global discriminator is used for receiving input of the overall image, and determining whether the overall image is the true or the false. The local discriminator is used for receiving input of the partial image, and determining whether the partial image is the true or the false. For example, the refined disparity map and the true disparity map may be divided into a plurality of image sub-blocks. Each image sub-block is input into the local discriminator to be determined whether it is the true or the false. Therefore, by designing the global discriminator and the local discriminator, the quality of the overall disparity map and the quality of the local disparity map can be concerned at the same time.

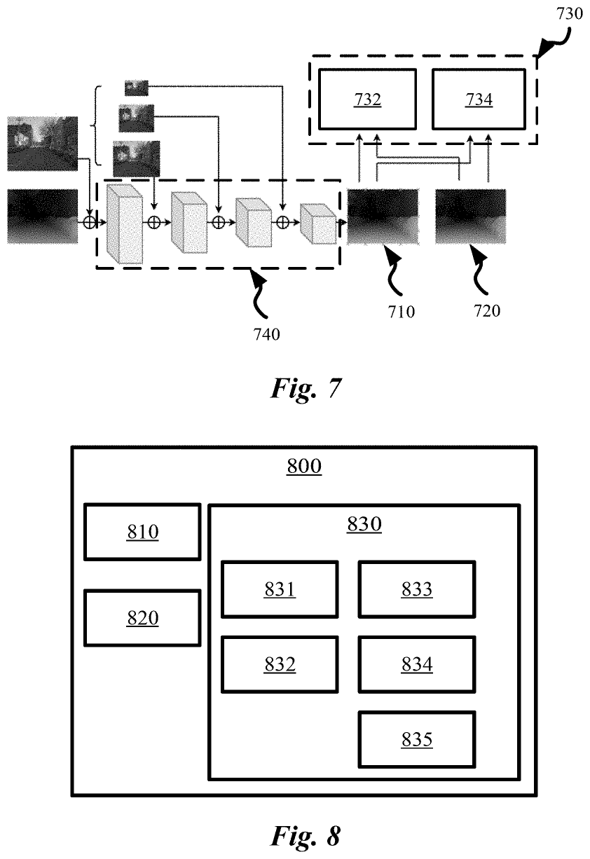

FIG. 7 shows an overall schematic diagram of determining disparity according to some embodiments of the present disclosure. As shown in FIG. 7, the refined disparity map 710 and the true disparity map 720 are input the discrimination network 730 together firstly. Then the disparity refinement network 740 is trained by learning until the preset discrimination condition is confirmed to. In an example, the discrimination network 730 may include a global discriminator 732 and a local discriminator 734.

FIG. 8 shows a structure block diagram of a disparity determining apparatus 800 according to some embodiments of the present disclosure. As shown in FIG. 8, the disparity determining apparatus 800 includes an obtaining module 810, a generating module 820 and a refining module 830.

The obtaining module 810 is configured to obtain a plurality of images corresponding to a target view, wherein each image in the plurality of images is obtained by performing size adjustment on the target view, and each image in the plurality of images has the same size as a feature map output by a corresponding layer structure in the disparity refinement network.

The generating module 820 is configured to generate an initial disparity map at least based on the target view.

The refining module 830 is configured to obtain a refined disparity map output by the disparity refinement network by at least inputting the initial disparity map into the disparity refinement network, fusing each image in the plurality of images and the feature map output by a corresponding layer structure, and inputting an image obtained by the fusing into the disparity refinement network.

In some example embodiments, each layer structure in the disparity refinement network includes a feature extraction layer and a pooling layer.

In some example embodiments, the refining module 830 includes a first fusing submodule 831 and a first inputting submodule 832.

The first fusing submodule 831 is configured to fuse the target view and the initial disparity map to obtain an initial fused image.

The first inputting submodule 832 is configured to input the initial fused image into the disparity refinement network.

In some example embodiments, the refining module 830 further includes a second fusing submodule 833, a second inputting submodule 834, and a determining submodule 835.

The second fusing submodule 833 is configured to fuse each image in the plurality of images and the feature map output by the corresponding layer structure so as to obtain a corresponding fused image.

The second inputting submodule 834 is configured to input the corresponding fused image into a next layer structure of the corresponding layer structure.

The determining submodule 835 is configured to determine the refined disparity map based on a last layer structure of the disparity refinement network.

In some example embodiments, the second fusing submodule 834 includes a first extracting submodule, a dimensionality reduction submodule and a third fusing submodule.

The first extracting submodule is configured to extract a feature map of a fused image input to the corresponding layer structure by utilizing the feature extraction layer of the corresponding layer structure, wherein the fused image input to the corresponding layer structure and the feature map extracted by the feature extraction layer of the corresponding layer structure both have a first size; and

the dimensionality reduction submodule is configured to perform dimensionality reduction on the extracted feature map by utilizing the pooling layer of the corresponding layer structure, so as to output a feature map having a second size.

The third fusing submodule is configured to fuse the feature map having the second size and another corresponding image in the plurality of images.

In some example embodiments, the determining submodule 835 includes a second extracting submodule and an upsampling submodule.

The second extracting submodule is configured to extract a feature map of a fused image input to the last layer structure by utilizing the last layer structure.

The upsampling submodule is configured to perform upsampling on the feature map extracted by the last layer structure so as to obtain the refined disparity map, wherein the refined disparity map has the same size as the target view.

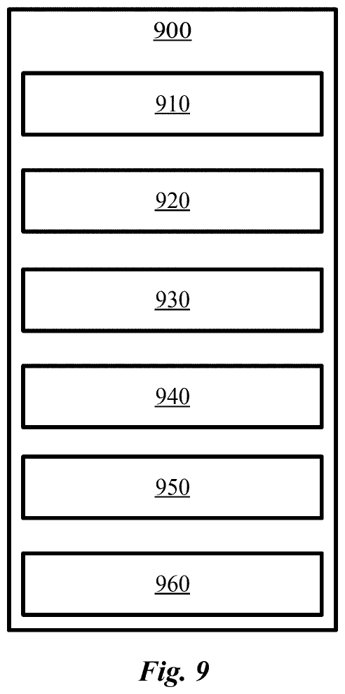

FIG. 9 shows a structure block diagram of a training apparatus 900 of a disparity refinement network according to some embodiments of the present disclosure. As shown in FIG. 9, the training apparatus 900 includes an obtaining module 910, a generating module 920, a determining module 930, a discriminating module 940, an updating module 950 and an iterating module 960.

The obtaining module 910 is configured to obtain a true disparity map and a plurality of sample images corresponding to a sample view, wherein each sample image in the plurality of sample images is obtained by performing size adjustment on the sample view, and each sample image in the plurality of sample images has the same size as a feature map output by a corresponding layer structure in the disparity refinement network.

The generating module 920 is configured to generate an initial sample disparity map at least based on the sample view.

The determining module 930 is configured to obtain a refined sample disparity map output by the disparity refinement network by at least inputting the initial sample disparity map into the disparity refinement network, fusing each sample image in the plurality of sample images and the feature map output by the corresponding layer structure, and inputting an image obtained by the fusing into the disparity refinement network.

The discriminating module 940 is configured to input the refined sample disparity map and the true disparity map into a discrimination network so as to determine a discrimination probability, wherein the discrimination probability is for characterizing a difference between the refined sample disparity map and the true disparity map, and the true disparity map has the same size as the refined sample disparity map.

The updating module 950 is configured to update parameters of the disparity refinement network and the discrimination network in response to that the discrimination probability does not conform to a preset discrimination condition.

The iterating module 960 is configured to iterate the above processes until the discrimination probability conforms to the preset discrimination condition.

In the technical solution of the present disclosure, related processing such as collecting, storing, using, processing, transmitting, providing and disclosing of user personal information all conforms to provisions of relevant laws and regulations, and does not violate public order and moral.

According to embodiments of the present disclosure, an electronic device, a readable storage medium and a computer program product are further provided.

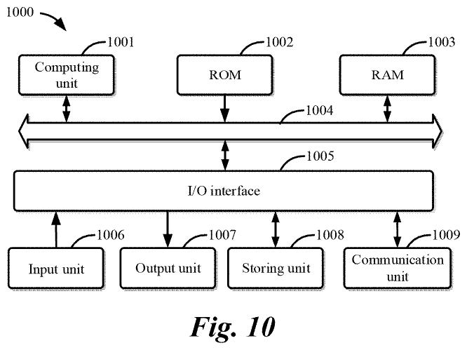

Referring to FIG. 10, a structure block diagram of an electronic device 1000 which can serve as a server or a client of the present disclosure will be described, which is an example capable of being applied to hardware devices of all aspects of the present disclosure. The electronic device aims to express various forms of digital-electronic computer devices, such as a laptop computer, a desk computer, a work bench, a personal digital assistant, a server, a blade server, a mainframe computer and other proper computers. The electronic device may further express various forms of mobile apparatuses, such as a personal digital assistant, a cellular phone, a smart phone, a wearable device and other similar computing apparatuses. Parts shown herein, their connection and relations, and their functions only serve as an example, and are not intended to limit implementation of the present disclosure described and/or required herein.

As shown in FIG. 10, the device 1000 includes a computing unit 1001, which may execute various motions and processing according to a computer program stored in a read-only memory (ROM) 1002 or a computer program loaded from a storing unit 1008 to a random access memory (RAM) 1003. In RAM 1003, various programs and data required by operation of the device 1000 may further be stored. The computing unit 1001, ROM 1002 and RAM 1003 are connected with one another through a bus 1004. An input/output (I/O) interface 1005 is also connected to the bus 1004.

A plurality of parts in the device 1000 are connected to the I/O interface 1005, and including: an input unit 1006, an output unit 1007, the storing unit 1008 and a communication unit 1009. The input unit 1006 may be any type of device capable of input information to the device 1000, the input unit 1006 may receive input digital or character information, generates key signal input relevant to user setting and/or functional control of the electronic device, and may include but not limited to a mouse, a keyboard, a touch screen, a trackpad, a trackball, an operating lever, a microphone and/or a remote control. The output unit 1007 may be any type of device capable of presenting information, and may include but not limited to a display, a loudspeaker, a video/audio output terminal, a vibrator and/or a printer. The storing unit 1008 may include but limited to a magnetic disc and an optical disc. The communication unit 1009 allows the device 1000 to exchange information/data with other devices through a computer network such as Internet and/or various telecommunication networks, and may include but not limited to a modem, a network card, an infrared communication device, a wireless communication transceiver and/or chip set, such as a Bluetooth™ device, a 1302.11 device, a WiFi device, a WiMax device, a cellular communication device and/or analogues.

The computing unit 1001 may be various general and/or dedicated processing components with processing and computing abilities. Some examples of the computing unit 1001 include but not limited to a central processing unit (CPU), a graphic processing unit (GPU), various dedicated artificial intelligence (AI) computing chips, various computing units running a machine learning model algorithm, a digital signal processor (DSP), and any proper processor, controller, microcontroller, etc. The computing unit 1001 executes all methods and processing described above, such as a method 200 and a method 600. For example, in some embodiments, the method 200 and the method 600 may be implemented as a computer software program, which is tangibly contained in a machine readable medium, such as the storing unit 1008. In some embodiments, part of all of the computer programs may be loaded into and/or mounted on the device 1000 via the ROM 1002 and/or the communication unit 1009. When the computer program is loaded to the RAM 1003 and executed by the computing unit 1001, one or more steps of the method 200 and the method 600 described above may be executed. Alternatively, in other embodiments, the computing unit 1001 may be configured to execute the method 200 and the method 600 through any other proper modes (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a load programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally away from each other and are usually interacted through the communication network. A relationship of the client and the server is generated through computer programs run on a corresponding computer and mutually having a client-server relationship. The server may be a cloud server or a server of a distributed system, or a server in combination with a blockchain.

It should be understood that various forms of flows shown above may be used to reorder, increase or delete the steps. For example, all the steps recorded in the present disclosure may be executed in parallel, may also be executed sequentially or in different sequences, as long as the expected result of the technical solution disclosed by the present disclosure may be implemented, which is not limited herein.

Although the embodiments or examples of the present disclosure have been described with reference to the accompanying drawings, it should be understood that the above method, system and device is only example embodiment or example, and the scope of the present disclosure is not limited by these embodiments or examples, but only limited by the authorized claim and its equivalent scope. Various elements in the embodiments or examples may be omitted or may be replaced with their equivalent elements. In addition, all the steps may be executed through the sequence different from that described in the present disclosure. Further, various elements in the embodiments or examples may be combined in various modes. It is important that with evolution of the technology, many elements described here may be replaced with the equivalent element appearing after the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of determining disparity by utilizing a disparity refinement network, the method comprising:
obtaining a plurality of images corresponding to a target view, wherein each image in the plurality of images is obtained by performing size adjustment on the target view, and each image in the plurality of images has a same size as a feature map output by a corresponding layer structure in a disparity refinement network, the disparity refinement network including a plurality of layer structures that are cascaded together;
generating an initial disparity map at least based on the target view; and
obtaining a refined disparity map output by the disparity refinement network at least by:
inputting the initial disparity map into the disparity refinement network,
fusing each image in the plurality of images and the feature map output by the corresponding layer structure, and
inputting an image obtained by the fusing into the disparity refinement network.

2. The method according to claim 1, wherein each layer structure in the disparity refinement network comprises a feature extraction layer and a pooling layer.

3. The method according to claim 1, wherein the obtaining a refined disparity map output by the disparity refinement network comprises:
fusing the target view and the initial disparity map to obtain an initial fused image; and
inputting the initial fused image into the disparity refinement network.

4. The method according to claim 2, wherein the obtaining a refined disparity map output by the disparity refinement network comprises:
fusing each image in the plurality of images and the feature map output by the corresponding layer structure to obtain a corresponding fused image;
inputting the corresponding fused image into a next layer structure of the corresponding layer structure; and
determining the refined disparity map based on a last layer structure of the disparity refinement network.

5. The method according to claim 4, wherein the fusing each image in the plurality of images and the feature map output by the corresponding layer structure comprises:
extracting a feature map of a fused image input to the corresponding layer structure by utilizing the feature extraction layer of the corresponding layer structure, wherein the fused image input to the corresponding layer structure and the feature map extracted by the feature extraction layer of the corresponding layer structure both have a first size;
performing dimensionality reduction on the extracted feature map by utilizing the pooling layer of the corresponding layer structure to output a feature map having a second size; and
fusing the feature map having the second size and another corresponding image in the plurality of images.

6. The method according to claim 4, wherein the determining the refined disparity map based on a last layer structure of the disparity refinement network comprises:
extracting a feature map of a fused image input to the last layer structure by utilizing the last layer structure; and
performing upsampling on the feature map extracted by the last layer structure to obtain the refined disparity map, wherein the refined disparity map has a same size as the target view.

7. The method according to claim 1, wherein the fusing each image in the plurality of images and the feature map output by the corresponding layer structure is performed by one or more of channel stacking, matrix multiplication or matrix addition.

8. An electronic device, comprising:
one or more processors; and
a memory storing one or more programs configured to be executed by the one or more processors, the one or more processors comprising instructions for causing the electronic device to perform operations comprising:
obtaining a plurality of images corresponding to a target view, wherein each image in the plurality of images is obtained by performing size adjustment on the target view, and each image in the plurality of images has a same size as a feature map output by a corresponding layer structure in a disparity refinement network, the disparity refinement network including a plurality of layer structures that are cascaded together;
generating an initial disparity map at least based on the target view; and
obtaining a refined disparity map output by the disparity refinement network at least by:
inputting the initial disparity map into the disparity refinement network,
fusing each image in the plurality of images and the feature map output by the corresponding layer structure, and
inputting an image obtained by the fusing into the disparity refinement network.

9. The electronic device according to claim 8, wherein each layer structure in the disparity refinement network comprises a feature extraction layer and a pooling layer.

10. The electronic device according to claim 8, wherein the obtaining a refined disparity map output by the disparity refinement network comprises:
fusing the target view and the initial disparity map to obtain an initial fused image; and
inputting the initial fused image into the disparity refinement network.

11. The electronic device according to claim 10, wherein the obtaining a refined disparity map output by the disparity refinement network comprises:
fusing each image in the plurality of images and the feature map output by the corresponding layer structure to obtain a corresponding fused image;
inputting the corresponding fused image into a next layer structure of the corresponding layer structure; and
determining the refined disparity map based on a last layer structure of the disparity refinement network.

12. The electronic device according to claim 11, wherein the fusing each image in the plurality of images and the feature map output by the corresponding layer structure comprises:
extracting a feature map of a fused image input to the corresponding layer structure by utilizing the feature extraction layer of the corresponding layer structure, wherein the fused image input to the corresponding layer structure and the feature map extracted by the feature extraction layer of the corresponding layer structure both have a first size;
performing dimensionality reduction on the extracted feature map by utilizing the pooling layer of the corresponding layer structure to output a feature map having a second size; and
fusing the feature map having the second size and another corresponding image in the plurality of images.

13. The electronic device according to claim 11, wherein the determining the refined disparity map based on a last layer structure of the disparity refinement network comprises:
extracting a feature map of a fused image input to the last layer structure by utilizing the last layer structure; and
performing upsampling on the feature map extracted by the last layer structure to obtain the refined disparity map, wherein the refined disparity map has a same size as the target view.

14. The electronic device according to claim 8, wherein the fusing each image in the plurality of images and the feature map output by the corresponding layer structure is performed by one or more of channel stacking, matrix multiplication or matrix addition.

15. A non-transient computer readable storage medium storing one or more programs, the one or more programs comprising instructions, which when executed by one or more processors of an electronic device, cause the electronic device to perform operations comprising:
obtaining a plurality of images corresponding to a target view, wherein each image in the plurality of images is obtained by performing size adjustment on the target view, and each image in the plurality of images has a same size as a feature map output by a corresponding layer structure in a disparity refinement network, the disparity refinement network including a plurality of layer structures that are cascaded together;
generating an initial disparity map at least based on the target view; and
obtaining a refined disparity map output by the disparity refinement network at least by:
inputting the initial disparity map into the disparity refinement network,
fusing each image in the plurality of images and the feature map output by the corresponding layer structure, and
inputting an image obtained by the fusing into the disparity refinement network.

16. The non-transient computer readable storage medium according to claim 15, wherein each layer structure in the disparity refinement network comprises a feature extraction layer and a pooling layer.

17. The non-transient computer readable storage medium according to claim 15, wherein the obtaining a refined disparity map output by the disparity refinement network comprises:
fusing the target view and the initial disparity map to obtain an initial fused image; and
inputting the initial fused image into the disparity refinement network.

18. The non-transient computer readable storage medium according to claim 17, wherein the obtaining a refined disparity map output by the disparity refinement network comprises:
fusing each image in the plurality of images and the feature map output by the corresponding layer structure to obtain a corresponding fused image;
inputting the corresponding fused image into a next layer structure of the corresponding layer structure; and
determining the refined disparity map based on a last layer structure of the disparity refinement network.

19. The non-transient computer readable storage medium according to claim 18, wherein the fusing each image in the plurality of images and the feature map output by the corresponding layer structure comprises:
extracting a feature map of a fused image input to the corresponding layer structure by utilizing the feature extraction layer of the corresponding layer structure, wherein the fused image input to the corresponding layer structure and the feature map extracted by the feature extraction layer of the corresponding layer structure both have a first size;
performing dimensionality reduction on the extracted feature map by utilizing the pooling layer of the corresponding layer structure to output a feature map having a second size; and
fusing the feature map having the second size and another corresponding image in the plurality of images.

20. The non-transient computer readable storage medium according to claim 18, wherein the determining the refined disparity map based on a last layer structure of the disparity refinement network comprises:
extracting a feature map of a fused image input to the last layer structure by utilizing the last layer structure; and
performing upsampling on the feature map extracted by the last layer structure to obtain the refined disparity map, wherein the refined disparity map has a same size as the target view.
